(19) United States
(12) Patent Application Publication
(10) Pub. No.: US 2023/0082558 A1
(43) Pub. Date: Mar. 16, 2023

(54) Retrofitting Small Watercraft as Collection Boats for Sargassum Seaweed

(71) Applicant: Aliquam Holding, LLC, Doral, FL (US)

(72) Inventors: Luke Gray, Exeter, NH (US); Alexander Slocum, Bow, NH (US)

(21) Appl. No.: 17/799,298

(22) PCT Filed: Feb. 12, 2021
(86) PCT No.: PCT/US2021/017873

§ 371 Date: Aug. 12, 2022

Related U.S. Application Data
(60) Provisional application No. 62/977,215, filed on Feb. 15, 2020.
(60) Provisional application No. 63/014,393, filed on Apr. 23, 2020.
(60) Provisional application No. 63/063,979, filed on Aug. 11, 2020.

(51) Int. Cl. A01D 44/00; B63B 35/32; B63B 83/20; E02B 15/10

(52) U.S. Cl. CPC A01D 44/00; B63B 35/32; B63B 83/20; E02B 15/10

(57) ABSTRACT

A module for retrofitting a boat for collection of floating biomass has a telescoping beam that spans the width of the boat and connects to aft-ends of levers that rest on the gunwales. The telescoping beam extends beyond both gunwales such that outboard net holders can be disposed thereon. Nets are attached to and held open by the net holders. The nets are at least partially submerged and fill with sargassum as the boat moves forward. Longitudinal drag forces are resisted by chains that connect the levers to the bow. Torsion around the telescoping beam is resisted by pretensioned straps that pass under the boat and over the aft-ends of the levers, which extend towards the bow to minimize strap tension and reaction force against gunwales. Horizontal moments in the outboard portions of the telescoping beam are absorbed by the inboard portion of the telescoping beam.

### CROSS-REFERENCES TO RELATED APPLICATIONS

This application claims the benefit of U.S. Provisional Application Nos. 62/977,215 filed Feb. 15, 2020; 63/014,393 filed Apr. 23, 2020; and 63/063,979 filed Aug. 11, 2020. The contents of these applications are incorporated herein by reference.

### BACKGROUND OF THE INVENTION

This invention relates to collecting sargassum seaweed using a retrofitted watercraft.

Floating macroalgaes, organisms, and other pelagic debris have caused serious problems for fishing and tourism industries worldwide. In particular, Caribbean beaches are being inundated by pelagic sargassum, a type of holopelagic (floating) macroalgae that has been growing in unprecedented quantities in the Central Western Atlantic (CWA), more specifically in the Northern Equatorial Recirculation Region (NERR), and causing much economic, social, ecological and environmental damage in the Caribbean region. This explosion of growth is thought to be caused by warmer ocean temperatures, increased ocean alkalinity, increased nutrient upwelling of the coast of West Africa, and increased iron dust depositing from the Sahara (due to deforestation of the borders of the Sahara), and increased agricultural runoff from the Amazon and Congo rivers. Rooted in climate change and improper land use by humans, these blooms seem certain to recur for years to come.

When sargassum makes landfall, it dies, rots, dyes water dark brown, creates an eyesore, emits a terrible smell, and inhibits swimming. This has significantly hurt tourism in Caribbean nations, where the industry directly contributes over 4% of combined GDP and supports over 700,000 jobs (WTTC, 2017). Additionally, sargassum has directly affected island life—fumes and airborne “dust” from the rotting sargassum can cause nausea, respiratory irritation, and corrosion of machinery. Direct contact from sargassum corrodes boats, breakwaters, and other man-made infrastructure. Thick mats of sargassum can stop small outboard motors, disrupting coastal villages and business activities. Fisherfolk are particularly harmed by sargassum because equipment is damaged and harvests have been severely diminished due to changing fisheries (species populations and travel patterns), as a result of sargassum blooms. Eutrophication from decay of the sargassum suffocates shallow-water animals and area coverage obstructs photosynthesis of benthic plants (ie. corals). Finally, decaying sargassum in coastal waters, on beaches, and in disposal areas/landfills emits large amounts of methane into the earth's atmosphere.

Current cleanup methods are expensive, visually polluting, and ineffective. At the time of this application, the dominant management method across the Caribbean, in civilian and high-value resort areas, alike, is manual cleanup on beaches (after sargassum has made landfall). High-value resort areas have started using heavy-duty machinery and some specialized machines for removing sargassum from beaches. In even more select locations, long lengths of floating barriers have been installed immediately in front of beaches. Specialized conveyor barges are used to clean sargassum from barriers. However, these machines cannot clean continuously and it is very expensive for them to clean small amounts of sargassum. Therefore, sargassum builds up against barriers, damaging them and/or eventually passing under/through and landing on beaches. Even beaches with millions of dollars of barriers and equipment still experience sargassum landings. In most places (civilian coastline), there is no means for sargassum management so locals are left to deal with negative effects to health and standards of living whilst compromising their own economic wellbeing to conduct manual cleanup efforts at their own cost.

It has been a decade since the start of sargassum inundations in the Caribbean and little progress has been made towards a Caribbean-wide solution. A solution is urgently needed to address the sargassum problem rapidly and for the entire Caribbean region.

It is extremely difficult to clear sargassum from beaches once it has made landfall and sand-laden sargassum cannot be transformed into saleable products to offset cleanup costs. Sargassum can be readily collected by skimming nets along the surface of water near shore and floating, filled nets can be conveniently transported without sand contamination. The Caribbean has more than enough small boats and skilled operators to perform this type of cleanup operation in tourist and civilian locations. It would therefore be extremely useful to provide an adjustable device that can retrofit onto any small boat and deploy large nets—too large to be held by hand—that can skim sargassum from the water's surface as the boat moves. Nets need to be held open, at least temporarily constrained at the waterline while towing, and located immediately next to the boat—one on either side—such that the nets can be efficiently and ergonomically filled and replaced with empty nets kept onboard. As nets fill, drag causes large longitudinal forces and eccentricities lead to large moments, which must be arrested or transferred through the device, to the boat. This is challenging because boats used for this purpose will be of diverse construction and condition. These boats will not be designed to absorb large forces so the device must be carefully designed to reduce applied forces and apply them in such a way so as to not overload any components of the boats, or else the safety of the operators could be in serious jeopardy.

### SUMMARY OF THE INVENTION

In one aspect, in general, an apparatus is used to retrofit a small boat in minutes, without any boat modifications, and safely arrests or transfers loads to the boat without relying on the existence or strength of any specific or special boat component(s). This apparatus offers the potential for rapid deployment across the Caribbean, to tourist and civilian locations providing immediate relief for tourism and opportunities for fishermen participation. This apparatus enables continuous cleaning at low marginal cost, even for small amounts of sargassum, which will help keep beaches cleaner (perhaps ˜100% clean for the first time) than is possible with current waterborne, conveyor-based cleaning machinery, which is expensive, can only be used periodically, and is visually polluting. This apparatus is also applicable to other types of floating biomass or debris in different parts of the world, such as algae, seaweed, jellyfish, and plastic.

In another aspect, in general, a collection module is retrofitted to a vessel (“watercraft,” “vessel” and “boat” may be used interchangeably). Said collection module holds nets on either side of said vessel, which fill with sargassum seaweed as said vessel moves through a body of water. Said collection module comprises channel levers that fit over gunwales on both sides of said vessel. Middle pipes attach to said channel levers and extend out, over both sides of said vessel. An inner pipe extends through both of said middle pipes and allows said middle pipes and said channel levers to adjust to the widths of different vessels (this assembly of middle pipes and inner pipe may be referred to collectively as the “telescoping beam”). Outer pipes slide over side middle pipes and possess insertion tubes. Vertical posts are secured inside said insertion tubes. Said vertical posts have net holders on their ends, which secure nets, hold them open, and fix them in the water on the port and starboard sides of said vessel. Nets are towed simultaneously (or one at a time while one of the two nets is being changed) on the port and starboard sides of the vessel, sargassum floating at the surface of the water being collected into said nets in the process. Said inner pipe, middle pipes, outer pipes, and vertical posts possess a plurality of holes for adjusting to the beam and freeboard of different vessels. Components are secured together with pins inserted through said holes. Said channel levers are secured to said vessel via straps that pass underneath said vessel and slings/chain that secure the entire collection module to the front/back of the vessel. Said vessel may be further outfitted with a structure around said vessel's propellers such that barriers, other infrastructure in the collection area, and the propellers themselves, are not accidentally damaged, a particular risk when operating in the dark. Said vessel may be outfitted with lights for operating in the dark (often required so that beaches are clean at the start of the day for tourist use). Said vessel may be fitted with a motor of at least 60 hp for operation in thick mats of sargassum. Additionally, reused nets are stored in various available space around the vessel for rapid/sustained replacement of filled nets. Nets can be opened/closed on at least one end, are designed to be buoyant/neutrally buoyant, they are reinforced with circumferential and/or lengthwise structural lines such that they can be towed away (perhaps daisy-chained together) through the water, then lifted and opened from the bottom such that they can be gravity discharged into a barge or truck or back into the water, etc. Floating towlines located near the collection area could be used to accumulate filled nets of sargassum. Said towlines (or individual filled nets), carrying said filled nets of sargassum, could then be towed away periodically, perhaps multiple of said towlines daisy-chained together, to open water for final disposal (e.g. sinking or dumping back into the ocean) or to land access points (on its way to landfill or transformation factory). Alternatively, individual nets, or towlines carrying filled nets could be emptied into a barge located near the collection area, which is periodically taken to open water for final disposal (e.g. sinking or dumping back into the ocean). This system is also applicable to other types of floating biomass or debris in different parts of the world, such as algae, seaweed, jellyfish, and plastic in the great garbage patch.

In another aspect, in general, an apparatus (100) is used to retrofit a watercraft (1) for collection of floating biomass (e.g., sargassum) (2) in a body of water. The apparatus includes an attachment structure (99), a plurality of net holders (101), which during operation are coupled to the attachment structure. Attachment elements (5, 6, 7) of the attachment structure transfer forces from the attachment structure to structural elements (e.g., the keel) of the watercraft during the collection. The plurality of net holders includes a first net holder and a second holder, which during collection are disposed at least partially submerged on opposite sides of the watercraft to maintain openings in respective collection nets (4) for collection of the floating biomass during forward motion of the watercraft. The attachment structure comprises a spanning member (110, 106) for attachment transverse across the watercraft, and two elongated mounting members (107) (e.g., channel levers) for attachment along gunwales of the watercraft to couple the spanning member to the gunwales (e.g., acting as levers). The attachment structure further comprises fastening elements (e.g., straps and/or chains), including at least one of a first fastening element (5) and a second fastening element (6, 7). The first fastening element is for attaching the elongated mounting members to the gunwales, such that during collection the first fastening element is configured to oppose torsional forces transmitted via the net holders and the spanning member to the elongated mounting members. The second fastening element is for coupling the support structure to a central structural element of the watercraft (e.g., the keel), such that during operation, the second fastening element is configured to oppose longitudinal forces transmitted through the net holders, spanning member, and elongated mounting members, induced by drag forces acting on the nets. Horizontal moments in outboard portions of the spanning member may be absorbed by the inboard portion of the spanning member via rotating connections to the elongated mounting members. The first net holder and the second net holder may form rigid openings for attachment of the respective collection nets. The apparatus may further comprise at least two nets for attachment to respective net holders.

In another aspect, in general, an apparatus for retrofitting small watercraft for collecting sargassum seaweed from a body of water, includes:

a. Mounting members that fit to the gunwales of said watercraft, which are secured with lashes, straps, chains, cable, rope, and/or slings;

b. Adjustable-length spanning member(s) that span the width of said watercraft and attach to said mounting members, adjusting to said watercraft of variable width;

c. Adjustable net holders attached to the outboard ends of said adjustable-length spanning member(s); and

d. Removable nets that attach to said net holders and are skimmed through said body of water as said watercraft moves, thereby collecting said sargassum seaweed.

Aspects can include one or more of the following:

The mounting members comprise channels that fit over said gunwales of said watercraft.

The said mounting members are secured via straps that pass underneath said watercraft.

The mounting members are secured via tensioning members that bear against the bow of said watercraft.

Slings encircle the nose of said watercraft and chains are attached between said slings and said mounting members.

The adjustable-length spanning member comprises nested pipes/tubes that telescope.

The adjustable-length spanning member comprises nested pipes/tubes that telescope and are pinned through pluralities of pinholes along their lengths.

The adjustable-length spanning member attaches to said mounting members via closed-loop features that fit over vertical posts attached to the tops of said mounting members.

The net holders are attached to said adjustable-length spanning member via vertical posts that are inserted/pinned into insertion tubes, said insertion tubes being attached to said adjustable-length spanning member.

The net holders are attached to said adjustable-length spanning member via vertical posts that are inserted/pinned into insertion tubes, said insertion tubes being attached to outer pipe sections that can be pinned/unpinned and slide along said adjustable-length spanning member.

The net holders are attached to said adjustable-length spanning member via vertical posts that are inserted/pinned into insertion tubes, said vertical posts having a plurality of pinholes along their lengths to adjust to freeboards of different watercraft.

The said net holders are rigid closed loop shapes with large openings in their centers to allow said sargassum seaweed to pass through.

The net holders fix said nets via hooks that hold loops on the ends of said nets.

The said net holders are equipped with rolling members on their outboard sides.

The net holders are equipped with funnel-like structures on the inboard & outboard sides.

All components are adjustable via pluralities of pinholes and pins to lock components in place.

All adjustable components are fixed via pins inserted into pinholes.

The mounting members are secured via an interference plate that inserts through said mounting members and engages the undersides of said gunwales of said watercraft.

The net holders are designed to fail, before any other components fail, in the case of excessive loading.

In another aspect, in general, an apparatus for storing filled nets of sargassum, includes:

a. A floating towline moored near the area where sargassum is collected into said filled nets, said filled nets of sargassum being attached to said floating towline along its length; and

b. A vessel that periodically tows said floating towline, carrying said filled nets of sargassum, to open water for disposal.

The disposal can comprise hoisting said filled nets of sargassum and opening their bottom ends such that sargassum contained therein is gravity discharged into said open water.

The disposal can comprise opening said filled nets of sargassum while they are still attached to said floating towline, and towing said floating towline such that said filled nets of sargassum empty in to said open water.

In another aspect, in general, a method for collecting sargassum using nets deployed from boats involves skimming long nets through the surface of the water where sargassum is floating. The nets are deployed from the vessels using modules that fit onto many different types and sizes of vessels. When nets are filled, each net is tied closed and left floating at the barrier/or on the beach (wherever collection is happening) for subsequent pickup and towing, perhaps in chains of nets, to storage/final disposal.

One or more aspects may provide the following advantages.

The approach may be used to retrofit a small boat in minutes, without requiring any boat modifications, and safely arrests or transfers loads to the boat without relying on the existence or strength of any specific or special boat component(s).

The apparatus includes a simple, low-cost modular system that rapidly installs/uninstalls onto many different types and sizes of vessels, from which nets are efficiently and conveniently deployed, skimmed, removed, and replaced.

The net holders fix nets and hold them open.

The apparatus can use a mass-manufactured tubular net that is easily secured, filled, detached, closed, towed, lifted, emptied, cleaned, and folded for repacking back inside the vessel for reuse.

Straps that hold said levers down, against said gunwales and/or slings that are secured to the bow of said vessel and chains extending from said slings that attach to said levers do not have to be permanently affixed to the vessel.

An assembly of nested pipes/tubes that telescope to span the beam of a given vessel (a “telescoping beam”)—a long inner pipe, two middle pipes that slide over said inner pipe and attach to said levers, and two outer pipes that slide over said middle pipes and possess insertion tubes for securing vertical posts attached to said net holders, can provide adjustability as well as high strength.

Use of pins to lock all rotary and linear degrees of freedom between adjustable components provides ease of adjustment by providing a number of pinholes on said inner pipe such that the position of said middle pipes, on said inner pipe, providing a number of pinholes on said middle pipes such that the positions of said outer pipes, on said middle pipes, and/or providing a number of pinholes on said vertical post extending from said net holders, such that the vertical position of said net holders can be adjusted to accommodate the freeboard of different vessels.

Providing insertion plates that insert into slots on the outboard sides of said levers and slide underneath said gunwales provides easy and secure attachment to the vessel.

Rolling members on the outboard sides of the said net holders can provide rolling contact with any obstacles (i.e., barriers) sargassum is accumulated against (to prevent damage to said obstacles and/or the net holders themselves).

A funnel-like structure on the inboard sides of said net holders such that sargassum deflected by the hull of said vessel, as it moves through a mat of sargassum, is directed into said nets, can increase the effective collection width of the system (to include the beam of the vessel) and improving the collection efficiency (less leakage), lowering the filling time of a single net for a given vessel speed.

A net that can be opened/closed on at least one end and gravity discharged by lifting through its axis can provide efficient operation.

A net with circumferential and/or lengthwise structural lines can provide structure for sustaining towing and lifting forces.

A net with a sufficiently fine mesh and a sufficiently large diameter-to-length ratio such that sargassum can be gravity discharged without too much sargassum clinging/entangling/wedging/jamming in netting.

A net made from nylon/polyester/polyethylene or other manufactured materials (ie. Dyneema), preferably one that is buoyant, or neutrally buoyant, can float as much as possible when filled with sargassum.

A net that is foldable/compactable enables many said nets to be stowed onboard said vessels.

Nets can be chained together and towed through the water to final disposal.

The apparatus provides an efficient means of attaching/detaching said nets to/from said net holders in operation.

A structure around said vessel's propellers is such that barriers, other infrastructure in the collection area, and the propellers themselves, are not damaged—a particular risk when operating in the dark.

Lights can be used for operation in the dark.

A vessel with greater than 60 hp motors can be used for operation, even in thick sargassum mats.

The filled said nets can be towed, for example, in chains of multiple said filled nets, away from the collection area.

Filled nets of sargassum can be stored on a floating towline located near said collection area.

The nets can be towed on towlines, carrying said filled nets of sargassum, out to open water for disposal. Towlines can be daisy chained together to form longer towlines carrying said filled nets.

The sargassum inside the filled nets, attached to said towlines, can be disposed by hoisting/dumping said filled nets into the ocean using a crane.

Other features and advantages of the invention are apparent from the following description, and from the claims.

### BRIEF DESCRIPTION OF THE DRAWINGS

FIGS. 1A-B are perspective views of a system for retrofitting a vessel as a sargassum collection vessel, which collects sargassum by skimming nets through the surface of the water where sargassum is floating.

FIG. 2 is a perspective view of a collection module to be retrofitted to a vessel such that it can be repurposed as a sargassum collection vessel.

FIG. 3 is an unfolded view of a net to be used with said collection module;

FIG. 4 is a folded view of a net to be used with said collection module (left) and a closeup view of the attachment method of said net during skimming/collection (right).

FIG. 5 is an illustration of a method of towing filled said nets through water by chaining them together.

FIG. 6 is a diagram of transport of collected sargassum through water, to final disposal;

FIG. 7 is a diagram illustrating a method for final disposal wherein a towline, carrying filled nets of sargassum, is reeled in as the filled nets are hoisted and dumped into the water;

### DETAILED DESCRIPTION

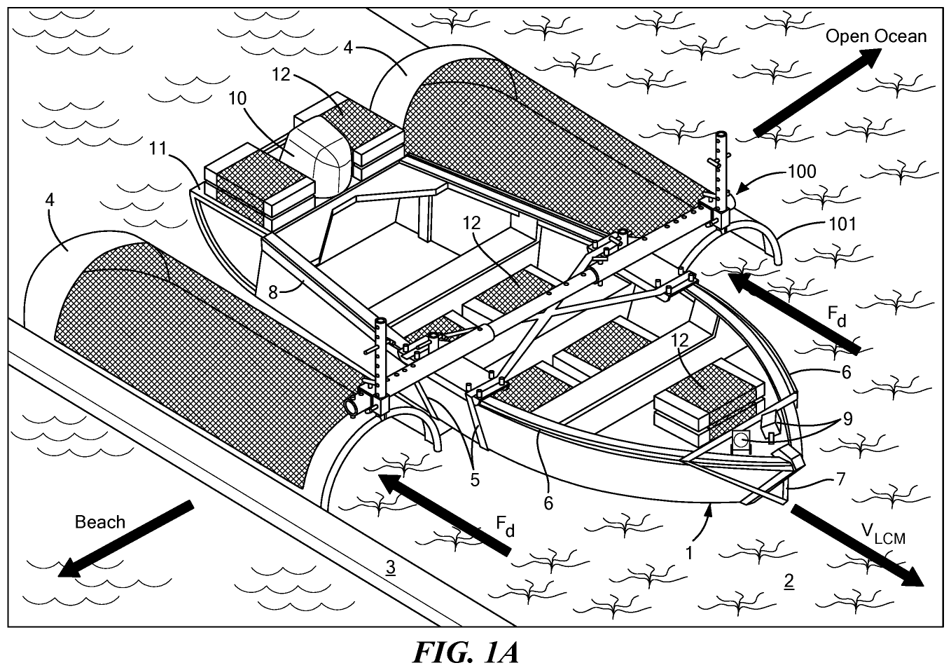

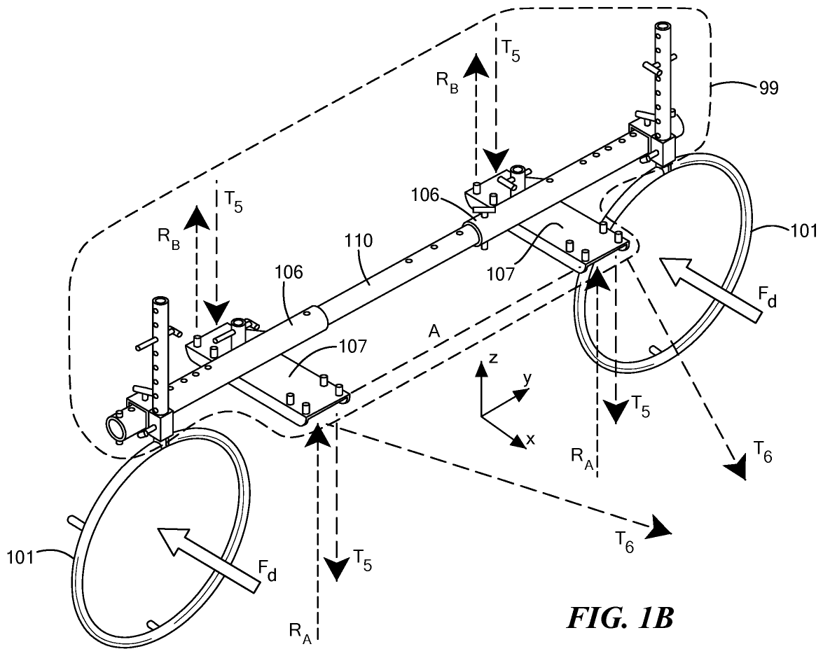

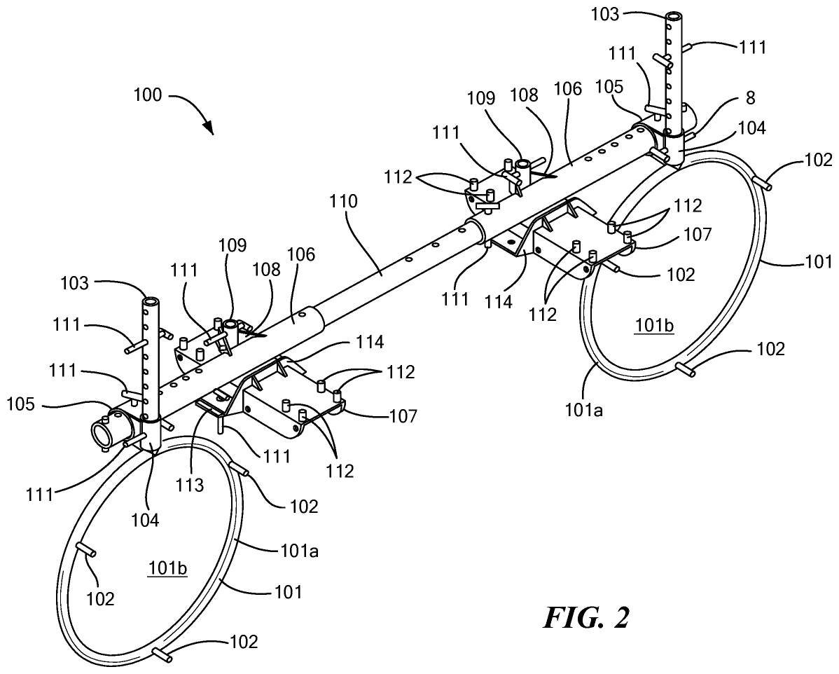

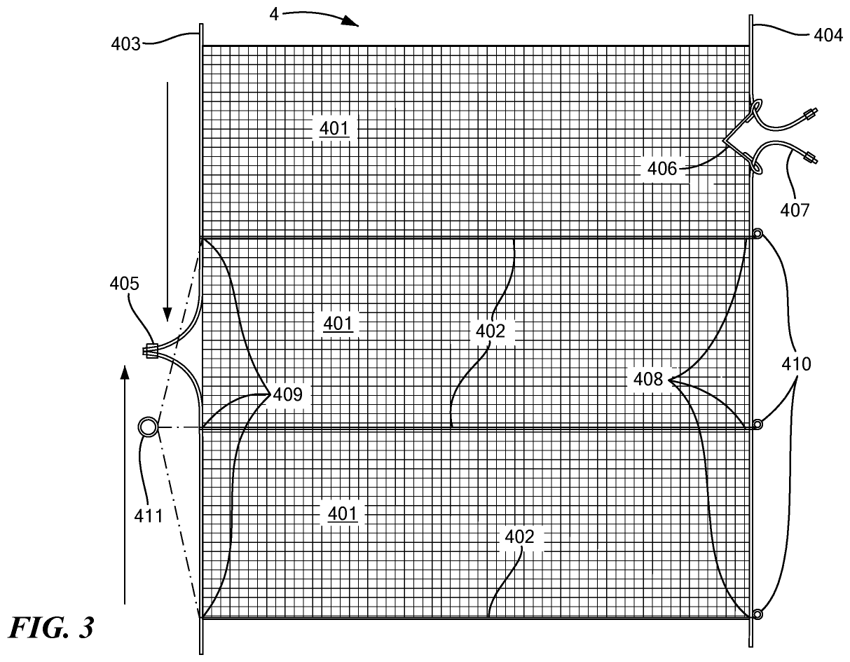

FIG. 1A shows an embodiment of a retrofit module for collecting floating biomass, in this example, floating sargassum. The module 100, which is used to retrofit a vessel 1, may be referred to below as the “LCM.” During collection, vessel 1 moves relative to sargassum 2 accumulated on barrier 3 (barriers are not required—collection can also be done offshore or along the beach so long as sargassum is in water of sufficient depth to accommodate draught of said vessel 1), collecting said sargassum 2 into nets 4. Collection module 100 is fitted to vessel 1. Collection module 100 is strapped down to vessel 1 by transverse straps 5. Collection module 100 is secured to the bow of vessel 1 by chains 6 attached to sling 7. Chains 6 may be pretensioned by strap 8 which extends around the stern of the vessel 1. Nets 4 are held by net holders 101 via rings 410 (see FIG. 3) and hooks 102 (see FIG. 2).

As shown, the bow of the vessel 1 splits the mat of sargassum 2, forcing it to flow around the sides of vessel 1 and into both deployed nets 4. Alternatively, just one net 4 may be deployed from one side of vessel 1 (while the other net holder 101 is reloaded on the other side or left idle).

Headlights 9 (and other cabin lights not shown) aid operation in the dark (which is often required such that beaches are clean for tourists at the start of each day). Vessel 1 is outfitted with an outboard motor 10 with >60 hp for optimal operation, even in thick sargassum mats. Vessel 1 is outfitted with stern guard 11 to protect barriers, and other structures in the collection area, from collision with the propeller of outboard motor 10 (this also protects nets from being tangled in said propeller of outboard motor 10 when making sharp turns with nets 4 deployed). Additional, empty, folded nets 12 are stored in various available space around the vessel 1 for rapid/sustained/repeated replacement of nets 4, once nets 4 are filled.

Sling 7 and chains 6 provide safety of collection module 100. Because collection module 100 is secured to used vessels of varying construction quality and maintenance condition, its safety is subject to the integrity of the vessel 1, particularly in the attachment areas, which may be in especially bad condition in some cases. The primary safety risk of collection module 100 is for it to detach and strike the vessel operators. This would most likely be caused by the net holders 101 striking ground/rocks/coral or because the operator is traveling with full nets at a speed greater than the maximum safe speed of ˜1.0 to 1.5 m/s, for example. Therefore, sling 7 bears on the bow of the vessel 1, where the keel and rails meet, which forms the strongest part of the vessel 1. The sling 7 relies on the bulk strength of this area of the vessel 1 (rather than relying on a specific area or component which may be missing or of poor construction/condition in many cases). This method of securement also maximizes compatibility and speed of collection module 100 assembly because most artisanal boats have a tapered, v-shaped bow where sling 7 can fit over (rather than relying on a specific area/component that may be missing or vary greatly from vessel-to-vessel). Sling 7 and chains 6 are the primary load bearing components of the system, resisting the drag on the nets 4 as they are towed through the water. Sling 7 may comprise a synthetic round web endless sling ˜3 ft long (˜6 ft in circumference). Chains 6 would attach to sling 7 and collection module 100 via shackles and/or links. Using a round endless sling for sling 7 will enable rotation to reduce excess wear on concentrated areas, it will adjust to the shape of different vessels' bows and give more control over the location of the shackle/chain connection points (compared to using two separate synthetic web flat eye slings that have nonadjustable lengths and may cause the shackles/chains to put unwanted pressure on the vessel in a nonideal location), and will be tolerant to large multi-planar angular changes (compared to flat synthetic web slings that are vulnerable to stress concentrations if twisted or bunched inside a shackle, for example). Chains 6 (and all other rigging accessories such as shackles, which connect sling 7, chains 6, straps 5 & 8, and channel levers 107) should be rated for lifting (e.g. Grade 80) and should be galvanized/zinc plated (or stainless—although this is very expensive) for corrosion resistance in salt water.

Note that net holders 101 are designed to fail (i.e., they have the lowest factor of safety compared to all other components in the collection module 100) before sling 7 or chains 6 fail. This should prevent sling 7 and chains 6 from ever approaching their maximum safe loads and will also require reporting any safety-related incidents to operation managers (net holders 101 must be repaired) so that the cause(s) of said incident can be ascertained and appropriate action taken to ensure it does not happen again.

The LCM is a safety-critical device. Designing the LCM to absorb large operational forces, regardless of the condition of the host boat, is not straightforward. Production designs for the LCM are supported by a closed-loop spreadsheet that calculates internal and contact stresses throughout the entire structural loop. Deterministic shape selection, member sizing, material selection, rigging accessories, weld quality, and proper assembly & maintenance instructions & training are critical to safe operation of the LCM. FIG. 1 shows a free-body diagram of the LCM.

Tiedown straps 5 prevent the LCM from tipping forward due to the eccentricity of loads F_{D} acting at the waterline. Lift-rated chains 6 are attached with shackles to LCM 100 and to a round, endless sling 7 that fits over the bow of boat 1 to resist drag forces F_{D}. The free-body diagram shows drag forces F_{D} acting on net holders 101. These forces are ultimately arrested by chain tension T₆. The tipping moment due to eccentricity of drag forces F_{D} about fulcrum axis A is arrested by rear tiedown tension T₅. Note that reaction forces R_{A} and R_{B}, where R_{B}<R_{A} in operation, are extremes in pressure distribution from A to B, which depends on flatness/contour of the gunwale. R_{B}>0 assuming preload T₅ is not overcome.

Drag force F_{D} on a filled net of sargassum with (d,l)=(1 m, 3 m) towed at the max operating speed of v_{LCM}=3 m/s can be as high as:

$${F}_{D} = \frac{1}{2} * {ρ}_{sw} * {C}_{D} * π * \frac{{d}^{2}}{4} * {v}_{LCM}^{2} > 7 , 000 \qquad [ N ]$$

Where C_{D}=2 is the max drag coefficient on a full net of sargassum assuming complete loss of momentum of displaced seawater. Even assuming no extreme chain angles, chain tensions could be >2,000 lbs. Channel levers increase the moment arm between the channel levers fulcrums and rear tiedowns. Still, with freeboard f=0.75 m, the tipping moment acting on the LCM could be:

Mₜᵢₚ=F_{D}*f>5,000 [N−m]

With channel lever length l_{channel}=0.75 m, the rear tiedown tension could be as high as:

$${T}_{5} = \frac{{M}_{tip}}{{l}_{channel}} > 7 , 000 \qquad [ N ]$$

Rated and certified pins, tie-downs, chains, shackles, links, slings, aluminum, and filler material is required. UV, saltwater, and mechanical wear can have a significant effect on the integrity of these components and must be inspected prior to every day of operation.

Net holders are designed with the lowest factor of safety such that at excessive operating speeds or in the case of a collision (e.g., with shallow rocks), net holders will fail predictably, protecting personnel and the rest of the LCM. For repairs to happen, all incidents must be reported, which enables causes to be identified and prevented in the future.

The round endless sling that fits over the bow of the boat, and the lift-rated shackles & chains that connect channel lever to the sling, rely on the bulk strength of the keel and gunwales to secure the LCM during regular operation and prevent it from striking operators during a collision. Other attachment mechanisms can place too much stress on specific and potentially damaged components of the boat being used, and are therefore not safe.

We strongly disapprove of any attempts to simply imitate the LCM device because if substandard parts are used, or if different design decisions are made, serious harm to people and/or equipment could occur.

FIGS. 1B and 2 show views of collection module 100. The module includes an attachment structure 99, which has a spanning member to which net holders 101 are attached during collection. Net holders 101 have vertical posts 103 that are pinned inside of insertion tubes 104. Said vertical posts possess a plurality of holes along their lengths such that they may be pinned, by pins 111, in varying locations inside insertion tubes 104 to adjust the height of net holders 101 to accommodate the freeboard of different vessels. The spanning member includes a number of tubes and pipes (these terms being used interchangeably to refer to tubular and/or cylindrical structures unless distinguished in context). Insertion tubes 104 are attached to outer pipes 105 that are pinned onto middle pipes 106. Middle pipes 106 possess a plurality of holes along their lengths so that the outboard positions of said outer pipes 105, as well as said net holders 101 and nets 4 secured thereunto, can be adjusted (and secured with pins 111). Said middle pipes 106 are secured to channel levers 107 via triangular sections 108 (triangular section 108 are attached to said middle pipes 106) that fit over vertical pegs 109 (vertical pegs 109 are attached to channel levers 107) and pinned in place by pins 111. An inner pipe 110 runs through said middle pipes 106, having a plurality of holes along its length so that the separation between triangular sections 108, on middle pipes 106, can be adjusted to fit the beam of different vessels. Inner pipe 110 is pinned inside one or both of said middle pipes 106 with pins 111 (in FIG. 2 there is only one pin 111 in one middle pipe 106 and pinholes only cover this half of inner pipe 110—one pin 111 on one side is all that is required to retain inner pipe 110 and this reduces the number of pinholes and pins 111 required).

Said triangular sections 108 can rotate around vertical pegs 109 (this helps with fitting over the gunwales of different vessels) so the moment caused by drag on the nets 4 and net holders 101 is arrested by the inner pipe 110. Shear caused by drag on the nets 4 and net holders 101 is arrested by the vertical pegs 109, attached to channel levers 107 which are held by chains 6 and sling 7 (FIG. 1). Twist caused by drag on the nets 4 and net holders 101 is arrested by the middle pipes 106, which apply a moment on channel levers 107. This moment is arrested by the transverse straps 5 (FIG. 1) holding channel levers 107 onto the gunwales of the vessel 1. Channel levers 107 have an extended length in the direction of the bow of vessel 1 to move the pivot farther from the rear transverse strap 5 reducing the tension required therein to resist the twist of the collection module 100 and reduce the forces applied to the gunwales of vessel 1.

All parts of collection module 100 are symmetrical/reversible so they can be used on either the port or starboard sides of the vessel 1. The front and backs of channel levers 107 have fairleads 112 to guide the transverse straps 5 and protect them from cutting/abrasion. All components are adjustable to retrofit to vessels of different beam and freeboard. All components are pinned in place with pins 111 inserted through the aforementioned pinholes. Assembling collection module 100 onto vessel 1 requires no tooling and no permanent modifications to vessel 1. Assembly takes <10 minutes and can be done at a dock or on a beach.

During transit of vessel 1, or while new nets are being reloaded onto net holders 101, net holders 101 are removed from the water by unpinning outer pipes 105 (and optionally vertical posts 103 as well) and rotating said net holders 101 up 180 degrees, and/or sliding them in towards vessel 1. Alternatively, vertical posts 103 could be completely removed from insertion tubes 104.

As an additional means of securing channel levers 107 onto the gunwales of vessel 1, the legs of channel levers 107 may also have slots wherein insertion plates 113 can be inserted and positioned underneath said gunwales of vessel 1 to resist uplift of channel levers 107 caused by twist from drag on nets 4 (discussed above). Insertion plates 113 are pinned in place with pins 111 and resulting torsion on channel levers 107 from loading of insertion plates 113 is resisted by torsional reinforcements 114. Said uplift is primarily resisted by transverse straps 5 (FIG. 1) as these straps can be preloaded and insertion plates 113 are optional, redundant features. Not to mention, relying on insertion plates 113 for resisting uplift of channel levers 107 would be subject to the shape, material, and strength of said gunwales on which insertion plates 113 would bear, which cannot be guaranteed.

This system is best used next to barriers (it offers the advantage that these lightweight craft can clean very close to barriers and can clean constantly even small amounts of sargassum at a low marginal cost whereas other specialized conveyor boats currently used cannot, meaning sargassum always sit next to the barrier where it bio-fouls said barrier and dissolves/rots, dyeing water brown, emitting a terrible smell, and passing through the barrier in small pieces, eventually landing on beaches) and while moving against the current (to promote feeding at lower vessel speed and increasing controllability next to barriers and other obstacles). However, these vessels could be used to clean immediately next to beaches so long as accumulated sargassum is still in a depth sufficient to accommodate the draught of the vessel 1 (sargassum that has already made landfall and been pushed up onto the beach could also be pushed back into the water for collection with this system—this is better than trying to collect from the beach directly because it avoids collecting much sand with the sargassum and compacting the sand with heavy machinery). This is important for cleaning civilian coastline where barriers are too expensive to implement. Overall, another benefit of this system is that the marginal collection cost is very low, meaning that many of these systems can operate continuously (whereas specialized conveyor boats currently used are only taken out once or twice a day) thereby keeping beaches cleaner than ever before—perhaps even 100% clean. Additionally, this system introduces no visual/noise pollution and can be implemented at low capital expenditure/lead time.

Instead of collecting sargassum from the ocean-side of the barrier 3 (FIG. 1), vessels 1 could use collection modules 100 to collect sargassum on the beach-side of barrier 3. This would mean collecting sargassum that has already pushed under/leaked through said barrier 3, in the shallow water on the beach-side of barrier 3, or even in the intertidal zone. This may lead to greater cost-effectiveness because time/money would not be wasted on that percentage of sargassum that washes off the ocean-side of said barrier 3 before said sargassum can pass under/leak through. In other words, collecting sargassum from the beach-side of barrier 3 means only collecting sargassum that has surpassed the first defense of the barrier 3, and is absolutely certain to land on beaches. This will hopefully mean that collection efforts could be better spent and beaches would be cleaner than they could be otherwise. However, on the beach-side of barrier 3, seagrasses, coral, rocks, and generally shallow water depth mean that large conveyor machines cannot operate there, whereas vessel 1 and collection module 100 can. Additionally, on the beach-side of the barrier 3, sargassum will be a moving target and may be more dispersed that when it was when sitting on the ocean-side of the barrier 3. Therefore, vessels 1 and collection modules 100 offer the distributed collection capacity and maneuverability necessary to collect sargassum before it lands on beaches (large conveyor machines could not do this).

This system offers the additional advantage that filled nets of sargassum can be towed away through water (instead of wheeled through tourists areas or villages). Once towed away from beaches/barriers, filled nets can be emptied into barges moored offshore, or attached to floating towlines, for further transport (or final disposal at sea), or loaded onto trucks for transport to proper landfills (so long as no toxicity present) or to transformation facilities (to make products—so long as no toxicity present). Filled nets can also be loaded onto submersible, modified boat trailers (towed by ATVs, for example), thereby removing said filled nets from water similar to how a boat is collected from a body of water at a boat ramp.

While not shown in FIGS. 1-2, a further evolution of the design might provide rolling members on the outboard sides of net holders 101 to provide rolling contact with any obstacles (e.g. barrier 3 in FIG. 1) sargassum is accumulated against (to prevent damage to said obstacles and/or the net holders 101 themselves). A further evolution of the design might also provide funnel-like structures on the inboard and/or outboard sides of said net holders 101 such that sargassum deflected by the hull of said vessel 1, as it moves through mat of sargassum 2, is directed into net 4, improving the collection efficiency (less leakage), lowering the filling time of a single net for a given vessel speed. Said funnel-like structures may comprise hydrodynamic fairings and/or pervious wire meshes that allow water to pass through while forcing sargassum towards the openings of nets 4.

Net holders 101 comprise a hoop 101a and an opening 101b therein. Hoop 101a keeps nets open during operation and sargassum flows through opening 101b into said nets. FIGS. 3 & 4 show the details of nets 4 (FIG. 1) and the preferred method of attaching nets 4 onto net holders 101, respectively. Note that net holders 101 could be rolled pipe/round tube (as shown), rolled square/rectangular tube, or rolled bar stock, etc., so long as they possess an opening for sargassum to flux through and a hoop/rim to attach nets to and hold said nets open.

Because vessel 1 (FIG. 1A) may be lightweight/low-displacement, net holders 101 have plenty of clearance/slop inside insertion tubes 104, and there are no snag-points/places where net holders 101 or nets 4 (FIG. 1A) can get caught, collection module 100 poses little risk to floating containment barriers (e.g. barrier 3 in FIG. 1A) if a collision takes place while collecting sargassum in close proximity (this is important as sargassum containment barriers are quite expensive; large conveyor based machinery used today can be pushed into barriers by waves and/or an unskilled operator, causing costly damages and liability for the operator). As mentioned above, this is one of the major advantages of collection module 100 because it can clean immediately next to containment barriers and even come into direct contact with containment barriers in order to remove all sargassum. However, if collection module 100 is frequently used to clean along docks, seawalls, quays, breakwaters, or other rigid infrastructure, there is the potential for minor damage to net holders 101 and/or said rigid infrastructure. Skill, reduced speed, and caution should be able to avoid most incidents. Manually keeping a physical offset from said rigid infrastructure using a pole or other implement is another simple but effective measure to avoid collision in these situations. While not shown, collection module 100 may also provide net holders 101 with spring preloaded breakaway mechanisms that reduce contact force in the case of a collision with said rigid infrastructure.

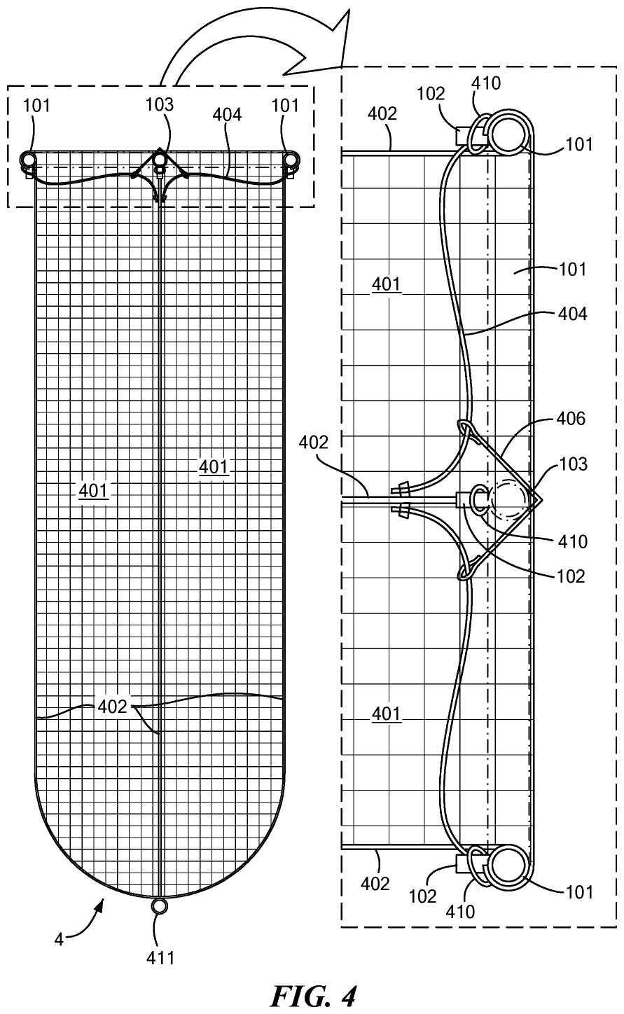

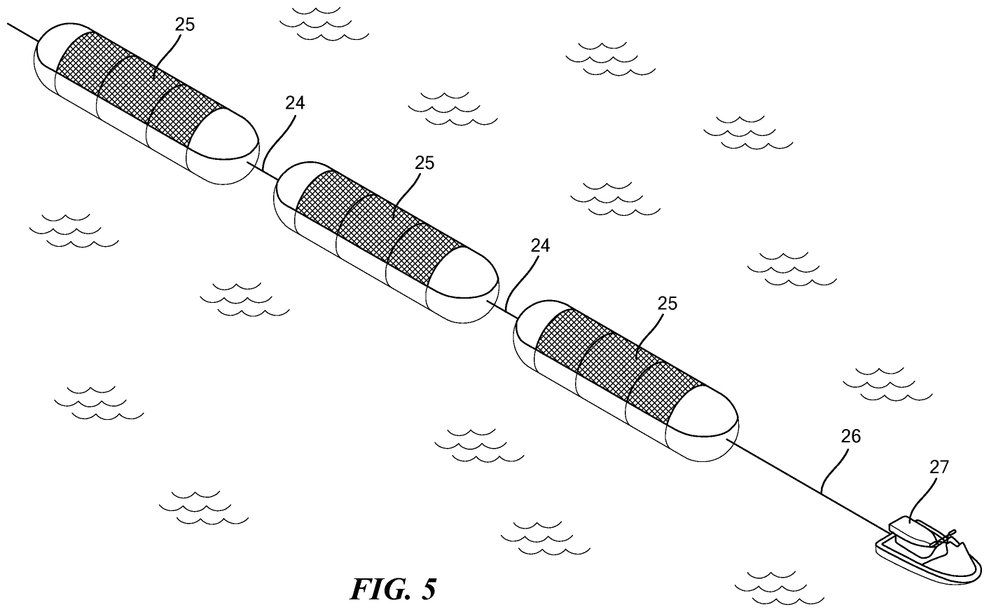

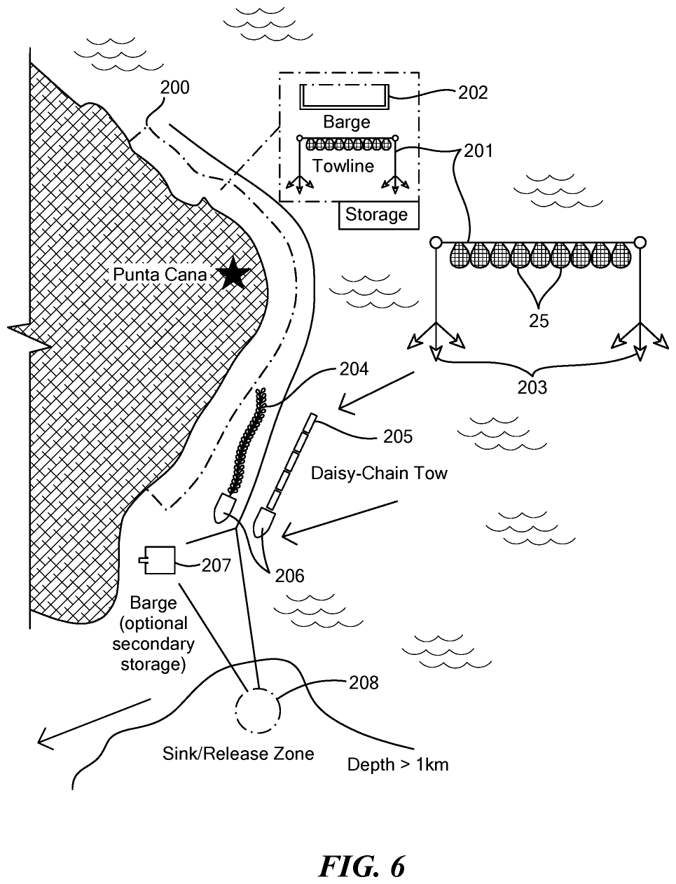

FIG. 3 shows an unfolded view of the preferred net 4 to be used with collection module 100. Structural lines 402 are woven through netting 401. Cinch ropes 403 & 404 are woven through the ends of netting 401. Cinch rope 403 is tightened and tied so that end of net 4 is permanently closed. Cinch rope 404 is adjustable for opening and closing that side of the net 4 and also for tying nets 4 onto net holders 101 (FIGS. 1,2, & 4). Cutout 406 accommodates vertical posts 103 (FIGS. 2 & 4) when nets 4 are wrapped around net holders 101 (see FIG. 4 for net attachment method). Cinch rope 404 has loose ends 407 that can be tied to close net 4, once filled, or to tie net 4 onto net holder 101. It is recommended to always use slip knots for easy release of all knots. Loose ends 407 have stevedore knots and burnt ends to keep loose ends 407 from unweaving from netting 401 and unbraiding/twisting (depending on the type of rope—braided rope preferred for cinch rope 404 and structural lines 402 for strength, abrasion resistance, and ease of knot-tying), respectively. Structural lines 402 comprise rope and they have permanent eyes 408 & 409 formed at their ends. Eyes 408 each have a ring 410 captured therein. Eyes 409 are all attached to a single ring 411. These rings can be used for lifting nets 4 such that they can be gravity discharged into a truck or barge, chaining nets 4 together for towing (FIG. 5), and for attaching nets 4 onto floating towlines for towing (FIGS. 6 & 7).

While netting 401 may be polyethylene, polyester, nylon, or any other material suitable for saltwater use, it is preferable for nets 4 to be designed to be buoyant. Fluorescent colors are also recommended for visibility and safety. Nets 4 may also be reinforced with circumferential structural lines (in addition to lengthwise structural lines 402). Nets 4 may also have solid/reinforced ends for structural purposes and to create lengthwise tension during initial towing (creating a “parachute effect”) such that the nets 4 are parallel to vessel 1 (FIG. 1) and said nets 4 remains open along its length to reduce resistance to sargassum filling (said solid ends are not necessary to create this effect, but certainly enhance it).

FIG. 4 shows a folded view of net 4 where netting 401 is rolled into a tubular net with longitudinal structural lines 402 (one of the structural lines 402 is used to splice the edges of netting 401 together to form said tube). As previously mentioned, one side of net 4 is permanently closed and all eyes 409 (FIG. 3) on that end are attached to a single ring 411. The open end of net 4 attaches to net holder 101 by inserting through the opening 101b (FIG. 2) in net holder 101 and wrapping back around the outside of the hoop 101a of the net holder 101 one half-turn (similar to a trash bag inverting/doubling-back over the rim of a trash barrel by 180 degrees). Rings 410 on the open side of net 4 attach onto hooks 102, which face backwards (preventing net 4 from being pulled through net holder 101 when skimming/collecting). Also shown is cutout 406 which accommodates vertical post 103 extending from net holder 101. Cinch rope 404 is also tied to further secure net 4 onto net holder 101 (recommend using a slip knot for easy removal from net holder 101 once nets 4 are filled). Rings 410 and hooks 102 are not absolutely necessary for attaching nets 4 onto net holders 101. As long as cinch rope 404 is tied tight around the backside of hoop 101a, nets 4 will be secured because the circumference of the tightened/tied cinch rope 404 will be less than the outer diameter of the hoop 101a. There is also the capstan friction effect brought about by the 180 degree wrap of netting around hoop 101a. If hooks 102 are removed, there is also less chance of nets 4 catching when filled and operators are trying to release nets from net holders 101 (this can sometimes be a nuisance). However, rings 410 are helpful for organizing nets 4 on net holders 101 (as nets tend to slip off during assembly otherwise).

The method of attaching net 4 onto net holder 101 via inverting/wrapping around the hoop 101a also ensures that net 4 is maximally open with minimal attachment points (e.g. hooks 102). If netting 401 did not invert/wrap around hoop 101a, then many more hooks 102 and rings 410 would be needed around the circumference of hoop 101a to ensure there are not chords/gaps between the opening of net 4 and the inside of hoop 101a, which would lead to leakage of sargassum (ie. sargassum enters opening 101b of net holder 101 but does not enter net 4).

As previously mentioned, once cinch rope 404 is tightened around hoop 101a, rings 410 loose tension and usually hang free/disengage from hooks 102. This aids removal of nets 4 once filled because the slip knot holding cinch rope 404 is simply pulled and the net 4 slips off of net holder 101. However, the hook 102 on the bottom sector of the hoop 101a (“bottom” defined as net holders 101 are deployed in the water as in FIG. 1) can sometimes snag on netting 401 and, because this hook is underwater and hard to see, it can sometimes be a nuisance to release the net 4. Therefore, said bottom hook 102 could be (1) removed (understanding that organizing net 4 and pulling cinch rope 404 over hoop 101a without netting slipping off may be more difficult), (2) shortened, or (3) operators must make sure that ring 410 engaging said bottom hook 102 is indeed always disengaged once cinch rope 404 is tightened/tied by purposely unhooking said ring 410 on said bottom hook 102 after said cinch rope 404 is tied around hoop 101a.

Note that nets 4 are cylindrical with ˜40″ diameter and 10-15 ft length. This net size is ideal for manual net changing (operators can only reach so far outboard) and engines 60-90 hp (towing full/partially full nets is limited by power of engines). However, nets 4 could be of any shape (rectangular prisms, triangular prisms, etc.) and width/length could vary greatly. The farther forward collection module 100 (FIGS. 1 & 2) is assembled on vessel 1 (FIG. 1) the longer nets 4 can be without getting caught in propellers of outboard motors. Net holders 101 may also vary in shape, according to the shape of the nets 4. Net holders 101 may also be eccentric, vertical posts 103 being offset from the center of opening 101b.

In the preferred net design, shown in FIGS. 3 & 4, net changes may take between 30-90 seconds (training and operator skill/experience is required to maximized efficiency). Alternatively, the preferred embodiment of net holders 101, shown in FIGS. 1 & 2, may be modified such that net holders 101 do not have to be taken out of the water to change nets. This could be accomplished by making the hoop 101a such that it is not a closed loop—for example, hoop 101a could just comprise the top half-circle of the preferred embodiment and further comprise legs extending vertically downwards from both ends of said half circle (“downward” defined when net holder 101 is deployed into the water as in FIG. 1). Hooks 102 (FIGS. 1 & 2) would be removed and a single hook would be added at the base of vertical post 103 (FIG. 2), where it attaches to hoop 101a, facing towards the bow of vessel 1 (FIG. 1) when net holder 101 is deployed. Each net 4 (FIG. 3) would further comprise a rigid ring inserted around the circumference (perhaps spring steel tape or a rolled small diameter pipe ˜1″), woven through netting 401 (FIG. 3), near the open end of net 4. Thereby, net 4 can be simply hung on said added hook at the base of vertical post 103, by said rigid ring, and said rigid ring would simply bear on the modified hoop 101a, behind it, when skimmed through the water collecting sargassum. When net 4 is filled, if can simply be pushed down and out of the modified hoop 101a, because hoop 101a is no-longer a closed loop, and a new net 4 can be hung rapidly, thereby eliminating the need for taking net holder 101 in/out of the water. However, these modifications to net holder 101 and net 4 would increase the cost of each. Alternatively, hoop 101a of net holder 101 can be left a closed loop, as in the preferred embodiment shown in FIGS. 1 & 2, and said rigid ring (spring steel tape or rolled small-diameter pipe) can be inserted around the circumference of nets 4, through netting 401, near the open end. Said rigid ring should be of a neutral axis diameter equal to/greater than hoop 101a, such that net 4 can be thrown through the opening 101b of net holder 101 and said rigid ring will be retained by hoop 101a (even an infinitesimally thin circular disc/ring cannot fit through another disc/ring of the same/greater diameter, unlike a square/rectangle whose side lengths can fit through their diagonals). This modification would also allow for net changes to be made without removing net holder 101 from the water—when net 4 fills it is pulled back through opening 101b (there can be no snags therefore hooks 102 are removed). Addition of the rigid ring to nets 4 will still increase the cost of every net. All of the aforementioned modifications should be reserved for service operations when operational efficiency is absolutely critical.

In the preferred embodiment of collection module 100, net holder 101 comprises a circular hoop 101a with opening 101b. The circular shape is simple to manufacture and eliminates snag-points that could potentially damage barriers. Alternatively, net holder 101 could comprise any shape, to aid collection from other, different locations and nets 4 could still be attached thereupon via the same method as in FIG. 4. Specifically, hoops could be flat-bottomed/square/rectangular for collection in extremely shallow areas or hoops could be tapered towards the bottom of vessel 1 (FIG. 1) for collection from breakwaters and intertidal zones/close to beaches.

A hoop 101a made out of rolled bar stock >6″ wide could insert into the openings of nets 4 far enough such that inverting nets 4 around hoops 101a (as in FIG. 4) is not necessary for keeping nets 4 fully open at entrance and therefore net 4 could simply fit over said bar stock hoop and rings 410 could simply engage hooks 102, which could face forward (although this presents the risk of snagging if collecting near a barrier with netting, for example).

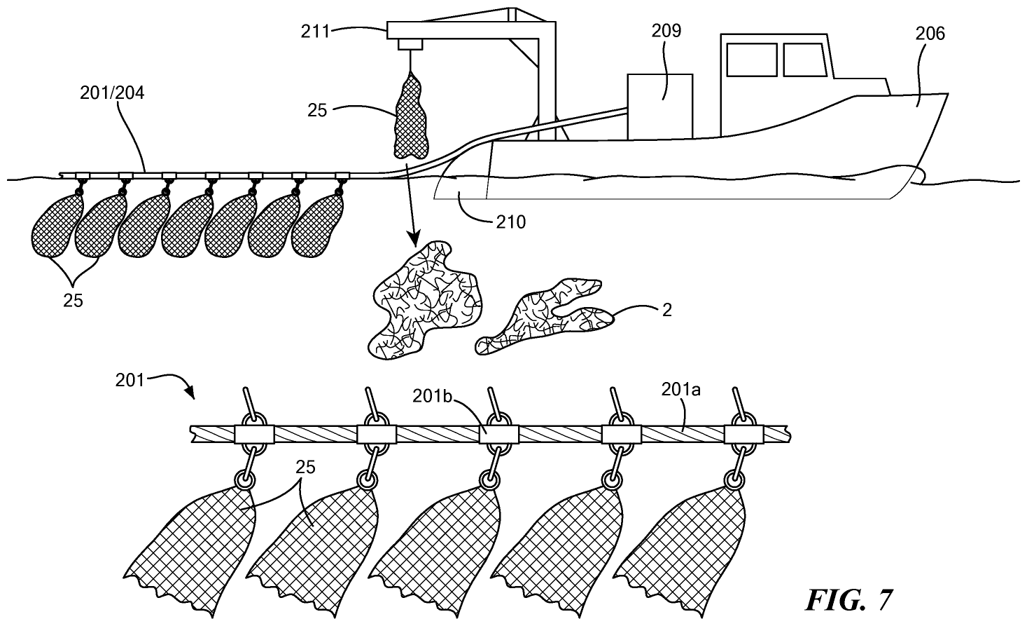

FIG. 5 shows the preferred method for towing away filled nets 25 of sargassum through the water (by their lengthwise structural lines 402 (FIGS. 3 & 4). This is more cost-effective and preferred to the present method of bringing sargassum through resort areas (through narrow/limited access points—sometimes even tourist throughways) to be loaded onto a truck (towing away via water eliminates visual pollution for tourists/civilians). Shuttling craft 27 are used to pickup and tow filled nets 25, that are left floating against barriers/beaches after being filled (this allows collection and transport to continue at the maximum rate without depending on any synchronization between the two processes). Filled nets 25 are simply released from net holders 101 (FIGS. 1 & 2) and later shuttling craft 27 retrieve them. Jet skis are the ideal shuttling craft 27 because they have a high power-to-drag ratio (don't waste power moving the shuttling craft 27 itself), a wide power band (can move at high speed with low load and low speed at high load) which means, after finishing a tow, they can return to the collection area very quickly/at high speed to pick-up more filled nets 25 (which means less shuttling craft 27 are required in a given area). Note that the shuttling craft 27 could also be the collection vessel itself (not ideal as these vessels should continue collecting, but since systems are usually built over capacity there may often be collection vessels available), or another specially designed vessel (as some resort areas have a ban on jet skis because of noise pollution). If collection vessels are to be used for towing filled nets 25, then filled nets 25 could be attached to the outboard portion of middle pipes 106 (FIG. 2) or said collection vessels used as shuttling craft 27 could have lines attached to pre-existing cleats or slings 7 on the bows of the vessels 1 (FIG. 1) such that vessels 1 can easily maneuver/“nose-” up to filled nets 25, floating next to barriers, for example, and attach said lines to rings 411 on filled nets 25. Alternatively, a long tow rope could be towed behind a shuttling craft such that many filled nets 25 could be attached along its length (e.g., floating towline 201 in FIG. 7; towline could be attached to two nylon ropes that attach to the outboard portions of middle pipes 106 from FIG. 2 to arrest shock loads during towing). Care must be taken to ensure netting and/or cinch ropes do not get caught in the propellers of motors (jet skis do not have this problem). If towed from cleats on the back of said collection vessels, care must be taken to ensure filled nets 25 are well-clear of propellers. Filled nets 25 could be daisy-chained together by connecting filled nets 25 together by their rings 410 & 411 (FIGS. 3 & 4) at junctions 24. The shuttling craft 27 should be separated from the nearest filled net 25 by an adequate length of towline 26 such that momentum can be efficiently imparted to the water/shuttling craft. While FIG. 5 shows filled nets 25 being towed through water (filled nets 25 are buoyant because of the sargassum contained therein), filled nets 25 may also be pulled onto a raft (e.g. pulled onto a pontoon raft using a ratcheting capstan) for towing and this may allow a greater number of filled nets 25 to be towed at one time (using the same shuttling craft 27).

Once towed away from beaches/barriers, filled nets 25 can be emptied into barges moored offshore or connected onto floating towlines (see FIGS. 6 & 7) anchored near collection areas, for storage, further transport, and final management. Final management may comprise bringing collected sargassum to proper landfills (so long as no toxicity present), to transformation facilities (to make products—again, so long as no toxicity present), or, preferably, said barges and/or towlines are towed out to open water for disposal via releasing into the ocean current (to continue on its way to the Sargasso Sea), or via sinking and sequestering in the deep ocean.

FIG. 6 shows an overview of how sargassum collected by collection modules 100 (FIG. 1), operating in collection area 200, could be stored and transported, using Punta Cana, Dominican Republic, as an example. Filled nets 25 (originally from FIG. 5) could be immediately towed to land access points for loading onto trucks (to be taken to landfill or transformation facilities), or, preferably, filled nets 25 could be connected to floating towlines 201 or emptied into barges 202, moored offshore near collection area 200 (FIG. 6 shows floating towline 201 moored by anchors 203). Said floating towlines 201 & barges 202 should be located near the high-activity collection areas (at hotels this is often locations along their barriers where there is exceptional sargassum leakage through/under said barriers due to stronger currents, for example), however said floating towlines 201 & barges 202 could also be moved between multiple moorings to minimize the distance filled nets must be towed at any given time, from any collection area. Floating towlines 201 & barges 202 could then be connected together into chains 204 & 205, respectively, and towed en masse to open water, to a sink/release zone 208. Chains 204 & 205 could be towed by towing vessel 206. Alternatively, barges 202 could be self-propelled. Chains 204 & 205 could be taken directly to sink/release zone 208, or first taken to a secondary storage 207, which is able to accumulate even more sargassum than chains 204 & 205, and is taken to sink/release zone 208 less frequently. At sink/release zone 208, sargassum is either released into the ocean current (e.g. via method in FIG. 7) or sunk via pumping the sargassum to a critical depth where sargassum pneumatocysts are sufficiently compressed such that the entire macroalgae is rendered negatively buoyant and sinks to the ocean floor. The latter method of disposal is described International Publication Number WO 2020/132673 A1.

FIG. 7 shows the aforementioned method of releasing sargassum back into the ocean. Towing vessel 206 (originally from FIG. 6) tows chain 204 (comprising floating towlines 201) to sink/release zone 208 (originally from FIG. 6). Then, floating towlines 201 are reeled into towing vessel 206, collecting onto reel/coiling pad 209. As floating towlines 201 are reeled in, filled nets 25 are detached and hoisted by crane 211 and sargassum 2 is emptied into the water. Filled nets 25 may be hoisted directly from the water or first pulled onboard towing vessel 206 (depending on the specific design of towing vessel 206 and the ability of rigging crew to access filled nets 25 in the water). If the latter, fairlead 210 may be included to reduce pulling force and risk of damage to filled nets 25 as they are pulled onboard. Once filled nets 25 are emptied, nets are stored away onboard towing vessel 206 to be returned for reuse in collection area 200 (FIG. 6). Floating towlines 201 are also returned to collection area 200 and re-moored. Note that reel/coiling pad 209 could be replaced by a wheel engine (with wheels that sandwich/pull towline onboard) and towline could be simply organized on the deck of towing vessel 206.

While FIG. 7 shows the preferred method of releasing sargassum from filled nets 25 at sink/release zone 208, another method may be to simply open filled nets 25 while still attached to floating towlines 201 and simply towing floating towlines 201 through the water until filled nets 25 have emptied (filled nets 25 would be opened using another, smaller vessel to travel up and down the chain 204 to open each filled net 25 once at the sink/release zone 208). That way, disposal can be performed by any towing vessel 206 (with sufficient towing power) without any onboard equipment or large stowage space. Then, floating towlines 201 could be simply towed back to collection area 200 and re-moored with empty nets still attached. Then collection vessels could retrieve said empty nets from said re-moored floating towlines for reuse. For filled nets 25 to empty by simply towing them through the water while attached to floating towlines 201, a higher diameter-to-length ratio on nets, greater spacing between nets on floating towlines 201, and finer mesh netting may be required to reduce jamming and entanglement of sargassum. Repeatedly jerking said nets on floating towlines 201 by stopping and restarting the pull, instead of pulling them at a constant rate, also helps to dislodge sargassum inside said nets. Lastly, if nets are to be emptied via simply opening them and towing them while still attached to floating towlines 201, then cinch rope 404 (FIG. 3) may be removed and filled nets 25 would instead be closed by separate/independent quick-release ties around the outside of the netting 401 at the entrance-sides of said filled nets 25. Said quick-release ties could be cam clamps (e.g. like ones for holding weights on barbells), an entangling pin (e.g. like a hairpin), or a snap-on-snap-off clip (e.g. like a bread bag clip). This way, said quick-release ties can be easily removed from a secondary vessel once towing vessel 206 reaches sink/release zone 208 and filled nets 25 would then be fully open without the risk of cinch ropes 404 remaining tight or retightening during towing, thereby preventing sargassum from emptying.

FIG. 7 also shows a close-up section of floating towline 201, comprising tow/mooring rope 201a and collars 201b (filled nets 25 being attached thereto). Tow/mooring rope 201a may comprise Dyneema engineered material, polyester, nylon, or another appropriate material (there are many high-strength synthetic ropes available off-the-shelf for towing). Collars 201b may be metal sleeves compressed/swaged onto tow/mooring rope 201a. It is important that each collar 201b be independently affixed to tow/mooring rope 201a, otherwise distal collars 201b (furthest from towing vessel 206) will bear the drag of all proximal filled nets 25. Collars 201b are provided with D-rings and clips (e.g., carabiners/latches) for quickly attaching/detaching filled nets 25 and/or emptied nets, respectively. Said clips may be on the ends of short sections of rope extending from each D-ring to increase range of motion and convenience/efficiency of attaching filled nets to towlines. Instead of collars 201b being metal sleeves swaged onto tow/mooring rope 201a, said short sections of rope could be tied through tow/mooring rope 201a (hawser ropes, for examples, comprise large braided strands that allow a smaller rope to the threaded through the braid). Pairs of nylon ropes may be used between floating towline 201 and towing vessel 206 in a bridle, to absorb shocks during towing.

In alternate manifestations of the collection module 100 (FIGS. 1 & 2), instead of deploying two nets 4 over the port and starboard sides of the vessel 1 (FIG. 1), net(s) could be deployed between two vessels or towed behind a single vessel. In said alternate manifestations, the collection module 100 may remain very similar to the preferred manifestation in FIGS. 1 & 2 in terms of how it attaches to vessel(s) 1. However, with two vessels, the vessels are connected together by a shared middle pipe (recall middle pipe 106 originally from FIG. 2) that spans between both said vessels and outer pipe(s) 105/insertion tube(s) 104/net holder(s) 101 (originally from FIG. 2) are attached at the midspan. If a net is towed behind a single vessel, the net would resemble a trawl net whose towlines are attached to the outboard portions of said middle pipes (no outer pipes, insertion tubes, or net holders in this manifestation).

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

1. An apparatus for retrofitting a watercraft for collection of floating biomass in a body of water, the apparatus comprising:
an attachment structure;
a plurality of net holders configured to be coupled to the attachment structure during the collection; and
wherein the attachment structure includes attachment elements for transfer for forces from the net holders to structural elements of the watercraft during the collection;
wherein the plurality of net holders includes a first net holder and a second net holder, which during collection are disposed at least partially submerged on opposite sides of the watercraft to maintain openings in respective collection nets for collection of the floating biomass during forward motion of the watercraft;
wherein the attachment structure comprises a spanning member for attachment transverse across the watercraft, and two elongated mounting members for attachment along gunwales of the watercraft to couple the spanning member to the gunwales;
wherein the apparatus further comprises fastening elements, including at least one of a first fastening element and a second fastening element;
wherein the first fastening element is for attaching the elongated mounting members to the gunwales, said first fastening element during collection is configured to oppose torsional forces transmitted via the net holders and the spanning member to the elongated mounting members; and
wherein the second fastening element is for coupling the attachment structure to a central structural element of the watercraft, said second fastening element during collection is configured to oppose longitudinal forces transmitted through the net holders, spanning member, and elongated mounting members, induced by drag forces acting on the nets.

2. The apparatus of claim 1, wherein the spanning member is configured to arrest horizontal moments, induced by outboard drag forces on filling nets of biomass, via rotating connections to the elongated mounting members.

3. The apparatus of claim 1, wherein the first net holder and the second net holder form rigid openings for attachment of the respective collection nets.

4. The apparatus of claim 1, wherein the apparatus further comprises at least two nets for attachment to respective net holders.

5. A watercraft retrofitted for collection of floating biomass having the apparatus of claim 1 attached thereto.

6. The apparatus of claim 1, wherein:
the fastening elements including at least one of lashes, straps, chains, cable, rope, and slings; and
the spanning member is configurable to adjust to span a width of the watercraft and to attach to said mounting members, thereby being adjustable to watercrafts of variable width.

7. The apparatus of claim 6, further comprising removably-attached nets that attach to said net holders so that in operation during forward motion of the watercraft, the nets are skimmed through said body of water as said watercraft moves, thereby collecting said floating biomass in the nets.

8. The apparatus of claim 6, wherein said mounting members comprise channels configured to fit over said gunwales of said watercraft and act as levers.

9. The apparatus of claim 6, wherein said mounting members are secured via straps that pass underneath said watercraft.

10. The apparatus of claim 6, wherein said mounting members are secured via tensioning members that bear against the bow of said watercraft.

11. The apparatus of claim 6, wherein slings encircle a nose of said watercraft and chains are attached between said slings and said mounting members.

12. The apparatus of claim 6, wherein said spanning member comprises nested pipes/tubes that telescope.

13. The apparatus of claim 6, wherein said spanning member comprises nested pipes/tubes that telescope and are pinned through pluralities of pinholes along their lengths.

14. The apparatus of claim 6, wherein said spanning member attaches to said mounting members via closed-loop features that fit over vertical posts attached to the tops of said mounting members.

15. The apparatus of claim 6, wherein said net holders are attached to said spanning member via vertical posts that are inserted/pinned into insertion tubes, said insertion tubes being attached to said adjustable-length spanning member.

16. The apparatus of claim 6, wherein said net holders are attached to said spanning member via vertical posts that are inserted/pinned into insertion tubes, said insertion tubes being attached to outer pipe sections that can be pinned/unpinned and slide along said adjustable-length spanning member.

17. The apparatus of claim 6, wherein said net holders are attached to said spanning member via vertical posts that are inserted/pinned into insertion tubes, said vertical posts having a plurality of pinholes along their lengths to adjust to freeboards of different watercraft.

18. The apparatus of claim 6, wherein said net holders are rigid closed loop shapes with large openings in their centers to allow said sargassum seaweed to pass through.

19. The apparatus of claim 6, wherein said net holders fix said nets via hooks that hold loops on the ends of said nets.

20. The apparatus of claim 6, wherein said net holders are equipped with rolling members on their outboard sides.

21. The apparatus in claim 6, wherein said net holders are equipped with funnel-like structures on the inboard and outboard sides.

22. The apparatus of claim 6, wherein components of the apparatus are adjustable via a plurality of pinholes and pins to lock components in place.

23. The apparatus of claim 6, wherein all adjustable components are fixed via pins inserted into pinholes.

24. The apparatus of claim 6, wherein said mounting members are secured via an interference plate that inserts through said mounting members and engages the undersides of said gunwales of said watercraft.

25. The apparatus of claim 6, wherein said net holders are designed to fail, before any other components fail, in the case of excessive loading.

26. An apparatus for storing filled nets of sargassum, comprising:
a floating towline moored near the area where sargassum is collected into said filled nets, said filled nets of sargassum being attached to said floating towline along its length.
a watercraft that periodically tows said floating towline, carrying said filled nets of sargassum, to open water for disposal.

27. The apparatus of claim 26, wherein said disposal comprises hoisting said filled nets of sargassum and opening their bottom ends such that sargassum contained therein is gravity discharged into said open water.

28. The apparatus of claim 26, wherein said disposal comprises opening said filled nets of sargassum while they are still attached to said floating towline, and towing said floating towline such that said filled nets of sargassum empty in to said open water.

29. A method for collection of floating biomass comprising:
attaching the apparatus of claim 1 to a watercraft;
attaching nets to the net holders of the apparatus; and
propelling the watercraft forward to cause the floating biomass to enter the nets.

30. The method of claim 29, wherein while propelling the watercraft forward, the method further comprises opposing torsional forces induced by the net holders on the spanning member with the first fastening element.

31. The method of claim 29, wherein while propelling the watercraft forward, the method further comprises opposing torsional forces transmitted via the net holders and the spanning member to the elongated mounting members via the first fastening element.

32. The method of claim 29, wherein while propelling the watercraft forward, the method further comprises opposing longitudinal forces transmitted through the net holders, spanning member, and elongated mounting members, induced by drag forces acting on the nets via the second fastening element.

33. The method of claim 29, wherein while propelling the watercraft forward, absorbing horizontal moments in outboard portions of the spanning member by an inboard portion of the spanning member via rotating connections to the elongated mounting members.

34. A kit for forming the apparatus of claim 1, the attachment structure, the plurality of net holders for coupling to the attachment structure, and the attachment elements, suitable for adjustable attachment to a vessel for collection of floating biomass.

35. The apparatus of claim 7, wherein the nets are attachable to the net holders by passing an open end of a net through or around a net holder, wrapping said open end of said net around the net holder, and tightening a cinch integrated around said open end of said net.

36. The apparatus of claim 35, wherein the net holders include hooks for arranging a net prior to tightening the cinch of the net.

37. The apparatus of claim 6, wherein adjustment of at least one of net holder height, net holder pitch angle, net holder lateral position, and mounting structure length is fixed via pins inserted into pinholes.

38. An apparatus for retrofitting a watercraft for collection of floating biomass in a body of water, the apparatus comprising:
an attachment structure;
a plurality of net holders configured to be coupled to the attachment structure during the collection; and
wherein the attachment structure includes attachment elements for transfer for forces from the net holders to structural elements of the watercraft during the collection;
wherein the plurality of net holders includes a first net holder and a second net holder, which during collection are disposed at least partially submerged on opposite sides of the watercraft to maintain openings in respective collection nets for collection of the floating biomass during forward motion of the watercraft;
wherein the attachment structure comprises a spanning member for attachment transverse across the watercraft, and two elongated mounting members for attachment along gunwales of the watercraft to couple the spanning member to the gunwales;
wherein the apparatus further comprises fastening elements, including at least one of a first fastening element and a second fastening element;
wherein the first fastening element is for attaching the elongated mounting members to the gunwales, said first fastening element during collection is configured to oppose torsional forces transmitted via the net holders and the spanning member to the elongated mounting members; and
wherein the second fastening element is for coupling the attachment structure to a central structural element of the watercraft, said second fastening element during collection is configured to oppose longitudinal forces transmitted through the net holders, spanning member, and elongated mounting members, induced by drag forces acting on the nets;
wherein the fastening elements including at least one of lashes, straps, chains, cable, rope, and slings;
the spanning member is configurable to adjust to span a width of the watercraft and to attach to said mounting members, thereby being adjustable to watercrafts of variable width; and
said mounting members are secured via straps that pass underneath said watercraft.

39. An apparatus for retrofitting a watercraft for collection of floating biomass in a body of water, the apparatus comprising:
an attachment structure;
a plurality of net holders configured to be coupled to the attachment structure during the collection; and
wherein the attachment structure includes attachment elements for transfer for forces from the net holders to structural elements of the watercraft during the collection;
wherein the plurality of net holders includes a first net holder and a second net holder, which during collection are disposed at least partially submerged on opposite sides of the watercraft to maintain openings in respective collection nets for collection of the floating biomass during forward motion of the watercraft;
wherein the attachment structure comprises a spanning member for attachment transverse across the watercraft, and two elongated mounting members for attachment along gunwales of the watercraft to couple the spanning member to the gunwales;
wherein the apparatus further comprises fastening elements, including at least one of a first fastening element and a second fastening element;
wherein the first fastening element is for attaching the elongated mounting members to the gunwales, said first fastening element during collection is configured to oppose torsional forces transmitted via the net holders and the spanning member to the elongated mounting members; and
wherein the second fastening element is for coupling the attachment structure to a central structural element of the watercraft, said second fastening element during collection is configured to oppose longitudinal forces transmitted through the net holders, spanning member, and elongated mounting members, induced by drag forces acting on the nets;
wherein the fastening elements including at least one of lashes, straps, chains, cable, rope, and slings;
the spanning member is configurable to adjust to span a width of the watercraft and to attach to said mounting members, thereby being adjustable to watercrafts of variable width; and
slings encircle a nose of said watercraft and chains are attached between said slings and said mounting members.
